(19) United States
(12) Patent Application Publication
(10) Pub. No.: US 2002/0133720 A1
(43) Pub. Date: Sep. 19, 2002

(54) Method for filtering the transmission of data on a computer network to Web domains

(75) Inventors: William E. Sherman, Maryland Heights, MO (US); Matthew B. Mee-Lee, Loma Linda, CA (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Clickgarden

(21) Appl. No.: 09/809,843

(22) Filed: Mar. 16, 2001

(51) Int. Cl. G06F 15/16

(52) U.S. Cl. 713/201; 709/217

(57) ABSTRACT

A process for preventing the unwanted transmission of information from a client computer to a host computer on the Internet. The process analyzes the HTML contents of a user-accessed Web page during the assembly of the Web page for display on the client computer. After identifying the domain name of the Web page and comparing that domain name to domain names of host computers from which elements of Web page will be obtained, the process prevents unwanted transmission of data from the client computer to such host computers by processing requests for such elements through a cookie filter and/or a URL filter. Upon examination of all requests for the transmission of data and the prevention of any unwanted transmission of such data, the process displays the accessed Web page on the client computer with or without the display of certain Web page elements depending upon the user's choice.

### CROSS-REFERENCE TO RELATED APPLICATIONS

None.

### STATEMENT REGARDING FEDERALLY SPONSORED RESEARCH OR DEVELOPMENT

Not Applicable.

### TECHNICAL FIELD

The present invention relates to a computer apparatus and method for preventing the unwanted transmission of user identification and other data to domains other than the domain of the Web page being displayed for the user, and more particularly, to a method and system for providing security to users who access Web pages over the Internet.

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical domain pages, also known as Web pages, of information to a remote client computer system, otherwise known as a user. The user's remote client computer system can then display the Web pages. Each resource (e.g., computer or Web page) of the WWW is uniquely identifiable by a Uniform Resource Locator (“URL”). To view a specific Web page, a user instructs the client computer system to specify the URL for that Web page in a request (e.g., a HyperText Transfer Protocol (“HTTP”) request). The request is forwarded to the Web server, otherwise known as the host computer, that supports that Web page. When that Web server receives the request, it sends that Web page to the client computer system. When the user's client computer system receives that Web page, it typically displays the Web page using a browser. A browser is a special-purpose application program used to request and display Web pages.

Web pages are typically defined using HyperText Markup Language (“HTML”). HTML provides a standard set of tags that define how a Web page is to be displayed. When a user instructs the browser to display a Web page, the browser sends a request to the host computer system to transfer to the client computer system an HTML document that defines the Web page. When the requested HTML document is received by the client computer system, the browser assembles and displays the Web page as defined by the HTML document. The HTML document contains various tags that control the displaying of text, graphics, controls, and other features. The HTML document may contain URLs of other Web pages available on that host computer system or other host computer systems.

Each Web page may also contain pictures, sounds and other elements in addition to text. Any of these other elements may originate from Web domains other than the Web domain from which the HTML originated. The HTML, and any other element, may be accompanied by a “cookie” when the HTML or other element is transmitted to the user's client system. The data associated with the cookie is then stored by the user's client system. Typically, the cookie's data contains a unique identifier created by the sending Web domain. A cookie's data is meant to be sent back to its originating domain on each subsequent communication with the originating domain, until the cookie expires at a date and time specified at the cookie's creation.

Tracking of an Internet user's activities can be achieved by utilizing a cookie planted by a single Web domain on the user's client system, when the cookie-planting domain is the source domain for pictures, sounds or other elements referenced within the HTML of Web pages originating from Web domains anywhere on the Web. The identification of the Web domain of the HTML, easily obtained, is a record to the cookie-planting domain of the user's visit to the Web domain of the HTML, and the cookie data is the unique identifier of the user. Large organizations currently exist which have the ability to thusly track user's activities across tens of thousands of sites. It should be noted that it is not necessary for a non-HTML element of a page to even be noticeable (visible, audible) to the user, and that some unnoticeable elements are created solely and specifically to implement the user-tracking process.

Additional information about the user's activities are commonly passed from the domain of the HTML to the domains of the non-HTML elements via the location specifier (the URL) associated with each of these non-HTML elements. This information commonly includes the HTML page identification and address, user specific information obtained from the HTML domain's cookie, and additional information such as the search terms that the user may have employed to find the page being displayed. In combination with the cookie data, this additional information provides the non-HTML domain with detailed identification and activity information that is readily databased and correlated with other previously gathered information. Most perniciously, this practice of transferring information from the HTML domain to non-HTML domains is in direct contravention of the cookie-handling specifications of the Internet which are intended to prevent unauthorized or unseen transfer of data between domains, particularly RFC 2109 Section 8.3, Unexpected Cookie Sharing, which states, “A user agent should make every attempt to prevent the sharing of session information between hosts that are in different domains. Embedded or inlined objects may cause particularly severe privacy problems if they can be used to share cookies between disparate hosts. For example, a malicious server could embed cookie information for host a.com in a URI for a CGI on host b.com. User agent implementors are strongly encouraged to prevent this sort of exchange whenever possible.” The domains receiving such information are typically owned by advertising firms with large database creation and maintenance activities.

Most browsers now provide Internet security options which attempt to provide the user with the ability to exercise some control over the usage of cookies sent to the user's client computer system. These browsers usually allow: (1) the user to disable all cookies sent to the user's client computer; (2) be notified when a cookies is being sent, and lets the user decide if the cookie will be accepted; or (3) simply allows all cookies to be accepted by the user's client computer system. Due to the ubiquitous use of cookies on the Internet, verifying all cookies sent to the user quickly becomes time consuming and annoying. Disabling all cookies sent is also unacceptable because many Web pages refuse access if the user elects to refuse to accept the cookies offered by the Web page. Additionally, the benefits of automated user recognition and site customization are lost if the user universally doesn't allow the transmission of cookies to any destination. These cookies have no effect on the passage of data via the URL of non-HTML elements, described in the previous paragraph. The passage of data via the URL of non-HTML elements can only be partially blocked, typically be turning off the display of all graphics from within the setup options of the browser. This is usually not acceptable, however, as many Web pages contain graphics that are visually necessary to the navigation of the page, or are desirable illustrations.

The present invention overcomes the problem of unwanted transmission of data to non-HTML domains in both the described forms: as cookie data, and as URL data. The invention provides three modes of operation. Mode 1 prevents the transmission of cookie data to non-HTML domains but allows the transmission of URL data. Mode 2 prevents the transmission of URL data but allows the transmission of cookies data to all domains except to the domains to which the transmission of URL data has been prevented. Mode 3 prevents the transmission of both cookie data and URL data to the non-HTML domains.

The present invention is different than all other cookie and advertisement blockers in that it employs techniques to distinguish between the domain of a Web page's HTML and the domains of the non-HTML elements comprising the Web page, and behaves differently depending upon the distinction so as to achieve the desired effect of eliminating unwanted data transmission, while retaining the positive benefits of cookie data destined for the HTML domain.

### SUMMARY OF THE INVENTION

Therefore, it is an object of the present invention to provide a computer apparatus and method for preventing the transmission of user identification data contained in cookies to Web domains referenced by the non-HTML elements of a Web page that are not the same domain as the HTML domain. The client computer system identifies the domain of the HTML, and subsequently checks the destination domain of every cookie being transmitted as a result of the rendering of the display of the Web page. Any cookie destined for a domain other than the HTML domain is either destroyed or gutted.

It is another object of the present invention to provide a method for preventing the transmission of data contained in the URL's of non-HTML elements. The client computer system identifies the domain of the HTML, and subsequently checks the destination of every non-HTML element request. If the destination is identified as a certain or probable domain of an advertising source, the request is cancelled, and a clear graphic element is instead substituted for use in rendering the Web page. Thus the request never leaves the client computer, and the transmission of data contained in the URL is blocked.

Icons and statistics may be displayed on the user's client computer to indicate the status of the client computer's treatment of cookies and URL'S.

Other objects and features of the present invention will be in part apparent and in part pointed out hereinafter.

### BRIEF DESCRIPTION OF THE DRAWINGS

FIG. 1 is a schematic illustration of the Internet system.

FIG. 2 is a flow diagram showing the initiation of the Transmission Filter Process.

FIG. 3 is a flow diagram of the Request for New Web Page Process.

FIG. 4 is a flow diagram of the Extraction of Name of Domain Owner Process.

FIG. 5 is sheet one of a flow diagram of the Assembly Of Accessed Web Page Process.

FIG. 6 is sheet two of a flow diagram of the Assembly Of Accessed Web Page Process.

FIG. 7 is a flow diagram of the URL Data Filter.

FIG. 8 is a flow diagram of the Cookie Handler For Case Of HTTP Protocol “Request Header” Not Yet assembled Process.

FIG. 9 is a flow diagram of the Cookie Handler For Case Of HTTP Protocol “Request Header” Already Assembled Process.

FIG. 10 is a flow diagram of the Handling Cookie By Manipulation Of HTTP Header Section Process.

Corresponding reference characters indicate corresponding parts throughout the several views of the drawings.

### DETAILED DESCRIPTION OF THE INVENTION

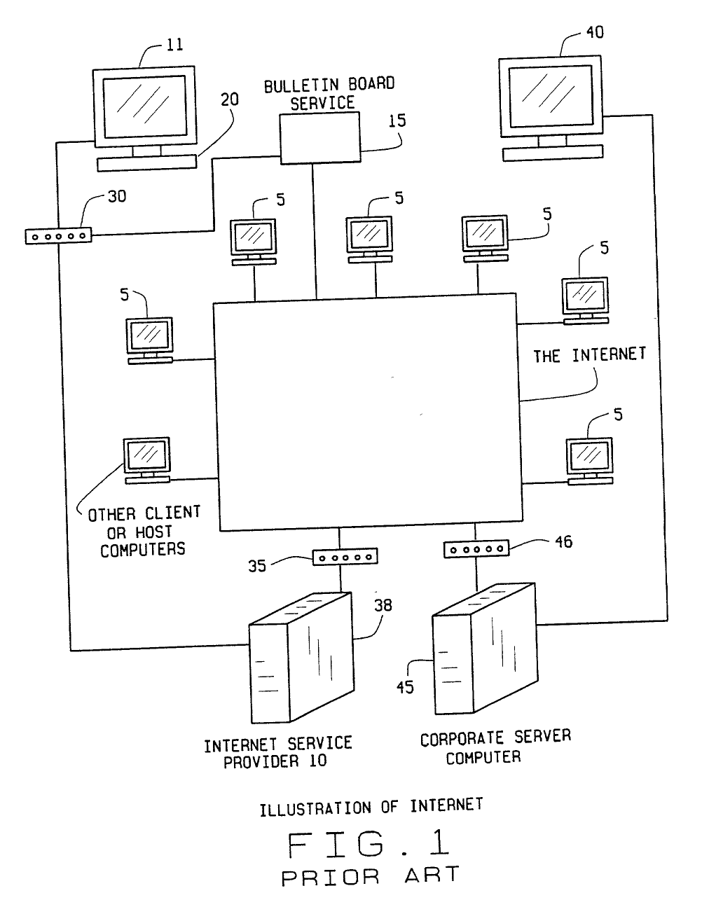

Now referring to the drawings, FIG. 1 depicts a schematic illustration of the Internet. The Internet 1 is a network of interconnected computers 5. This includes systems owned by Internet service providers 10 and information system bulletin board services 15 such as Compuserve or America Online. Individual or corporate users may establish connections to the Internet in several ways. An individual user 11 of a home computer 20 may purchase an Internet access account through an Internet service provider 10. The home computer 20 includes a non-volatile storage device and a display monitor linked to the home computer 20. Using a modem 30, the home user can dial up the Internet service provider 10 to connect to a high speed modem 35 which provides full service connections to the Internet through the server computer 38 of the Internet service provider 10. The server computer 38 of the Internet service provider 10 is identified by a URL assigned to it by the administrators of the Internet. A corporate user 40 is normally connected to a server computer 45 located at the corporate location. The corporate server computer 45 is also connected to the Internet by a high speed modem 46 and the server computer is also identified by a URL assigned to it by the Internet administrators.

Whether the user is an individual user 11 or a corporate user 40, the computer system used by each is identified as the client computer. Once access to the Internet is provided by either an Internet service provider 10 or by the server computer 45 at the corporate location, the client computer accesses Web pages by connecting to another server computer identified as the host computer. Each host computer is identified by a URL assigned to it by the Internet administrator.

The embodiment described herein requires the use or creation of a browser program which incorporates the present invention. There are a number of currently available Internet browser toolkits which allow programmers to generate special versions of an Internet browser. During the creation of such a browser, the current invention can be incorporated into the functions of the newly generated browser.

It is clear that in another embodiment of the present invention, the embodiment would permit the operation of the present invention in conjunction with the Netscape and Internet Explorer browsers, or any other Internet browser, in the event that those browsers allow the present invention to interface with the browser in a manner to allow the present invention to execute appropriate monitoring and control over transmissions of data to and from the client computer.

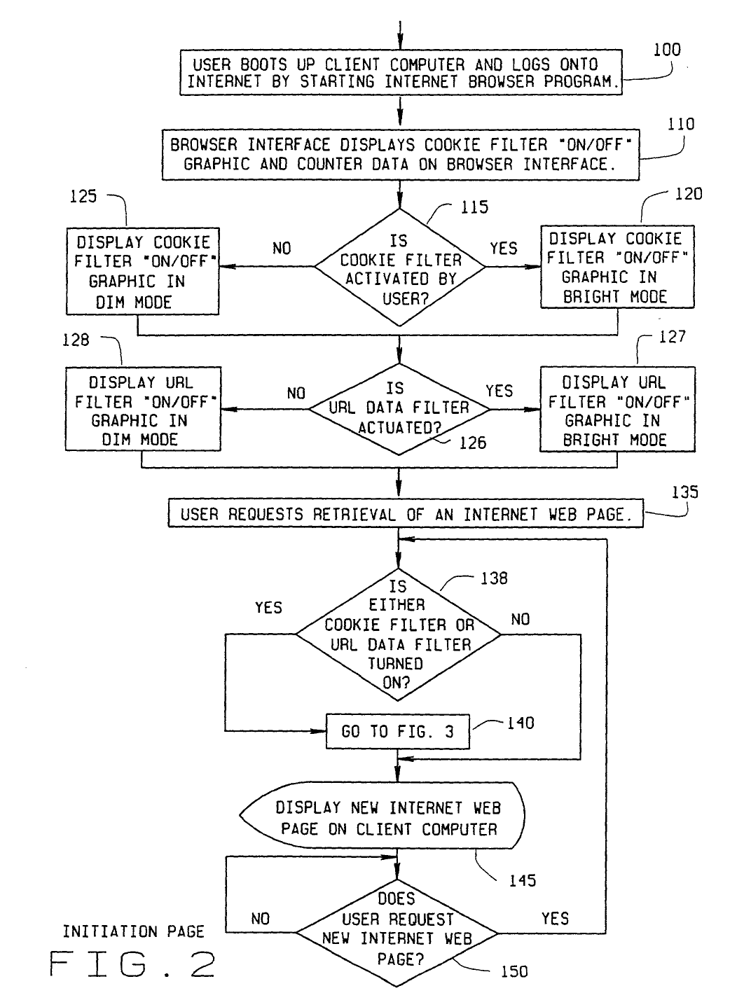

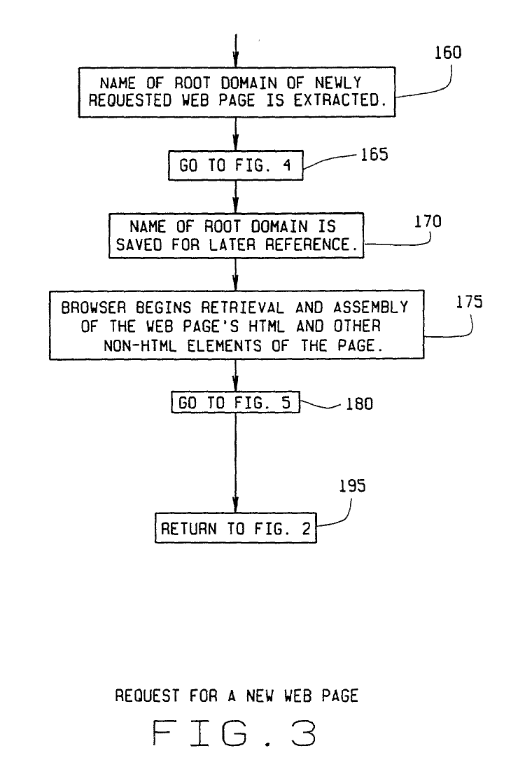

The computer apparatus and method described herein generally comprises various program components stored on the non-volatile data storage device of the computer 20. Referring now to FIG. 2, this drawing illustrates the Initiation Page of the present invention. In Step 100, the user boots up the client computer and logs onto the Internet by starting the Internet browser program installed on the client computer. In Step 110, the browser graphical interface displays the status of the cookie filtering process of the present invention by displaying a graphic on the tool bar of the browser. In Step 115, the browser determines whether the cookie filter process is activated by the user. If the cookie filter was activated by the user, Step 120 shows the cookie filter as being activated by displaying the cookie filter activation graphic on the tool bar in a bright display mode. If the cookie filter is not activated, Step 125 causes the cookie filter activation graphic on the tool bar to be displayed in a dim mode.

In Step 126, the browser graphical interface displays the status of the URL data filter of the present invention by displaying another graphic on the tool bar of the browser. In Step 126, the browser determines whether the URL data filter process is activated by the user. If the URL filter was activated by the user, Step 127 shows the URL data filter as being activated by displaying the URL data filter activation graphic on the tool bar in a bright display mode. If the URL data filter is not activated, Step 128 causes the URL data filter activation graphic on the tool bar to be displayed in a dim mode.

After the browser is initiated and the cookie filter and URL data filter activation graphics are properly displayed on the browser tool bar, the browser then accesses the default Web page selected by the user for display upon initiation of the browser. When the user requests that another Web page be accessed as shown in Step 135, then in Step 138 the browser checks the status of the cookie filter and the URL data filter. If either filter is activated, execution is transferred to FIG. 3, Request for New Web Page Process by Step 140. If neither filter is activated, the Internet Web page requested by the user is displayed in Step 145. The browser checks continuously until the user requests the retrieval of a new Internet Web page in Step 150. If Step 150 indicates that a new Web page has been requested, execution is transferred to Step 138, where the process is repeated beginning with Step 138.

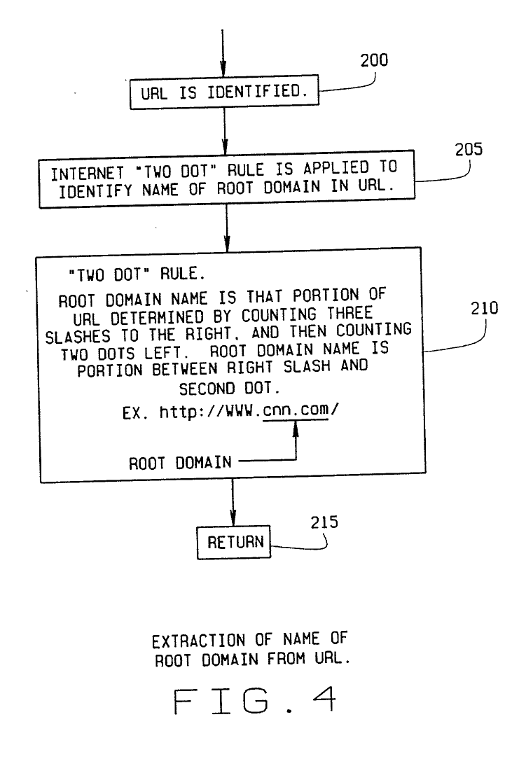

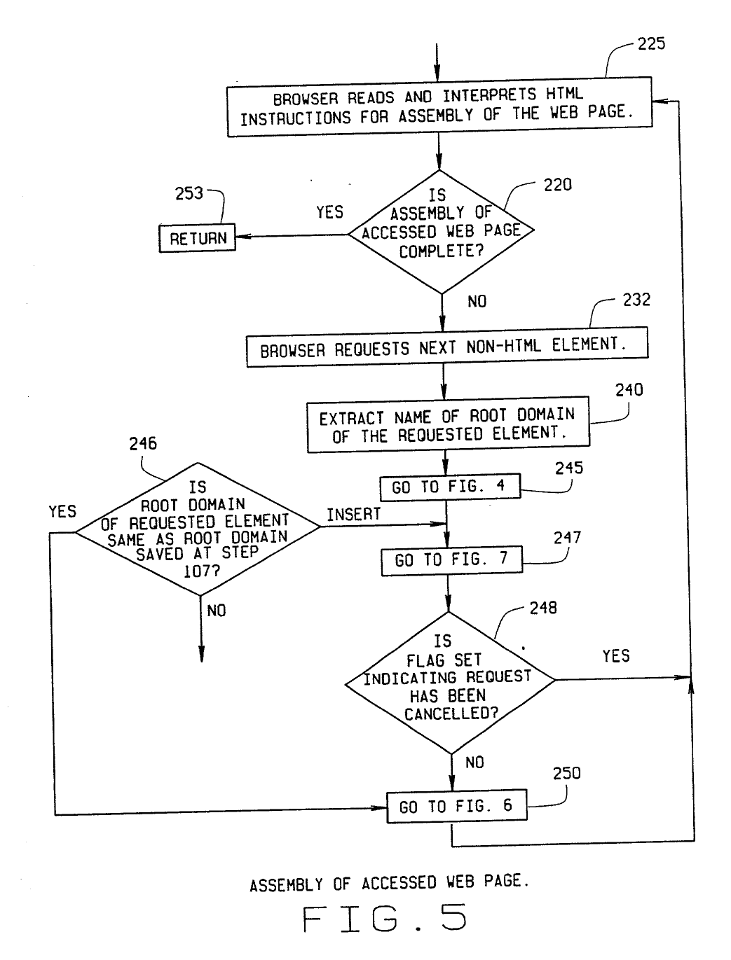

When the user instructs the Internet browser on the client computer to access a new Internet Web page and either the cookie filter or the URL data filter is activated, Step 140 transfers execution to FIG. 3, Step 160, where the present invention extracts the name of the domain owner of the new Web page being accessed. To accomplish this task, Step 165 transfers execution to the Extraction Of Name Of Root Domain From URL Process depicted in FIG. 4. In Step 200 of FIG. 4, the URL of the new Web page being accessed is identified. Using the “Two-Dot Ownership” rule in use on the Internet, Step 205 applies this rule to the identified URL. In Step 210, the Two-Dot Ownership rule extracts the name of the root domain owning the Web page by counting three slashes, i.e., three “/”, to the right in the URL, and then counting two dots, i.e., two “.” back to the left in the URL. The text contained between the third slash and the second dot is the name of the root domain owning the Web page being accessed by the user. For example, if the full URL of the Web page is “http://www.cnn.com/WEATHER/”, the name of the domain owner is “cnn.com”, the text between the third slash to the right and then back to the second dot to the left. After the name of the root domain owning the Web page is extracted from the URL, Step 215 returns execution back to the Request For New Web Page Process in FIG. 3, Step 170 where the name of the root domain is saved for later reference by the browser. There are well-known exceptions to this rule for domains ending in some country codes; e.g., “http:/www.domain.co.uk” which would correctly yield “domain.co.uk” not “co.uk.”

Step 175 begins the assembly of the Web page accessed by the user by beginning the retrieval and assembly of the Web page's HTML and other non-HTML elements of the Web page. As part of this process, Step 180 immediately transfers execution to Step 225 of FIG. 5 to initiate the Assembly Of Accessed Web Page Process. As the first step in this process, Step 220 first checks to see if the Web page assembly is completed. This step is required because the assembly of the accessed Web page is an iterative process which requires verification of all cookies and page elements to prevent unwanted transmission of data from the client computer. If assembly of the accessed Web page is completed, Step 253, returns execution to Step 185 of FIG. 3 to check for requests for the transmission of cookie information from the client computer to the host computer. If the assembly of the accessed Web page is not complete, Step 232 requests the next non-HTML element.

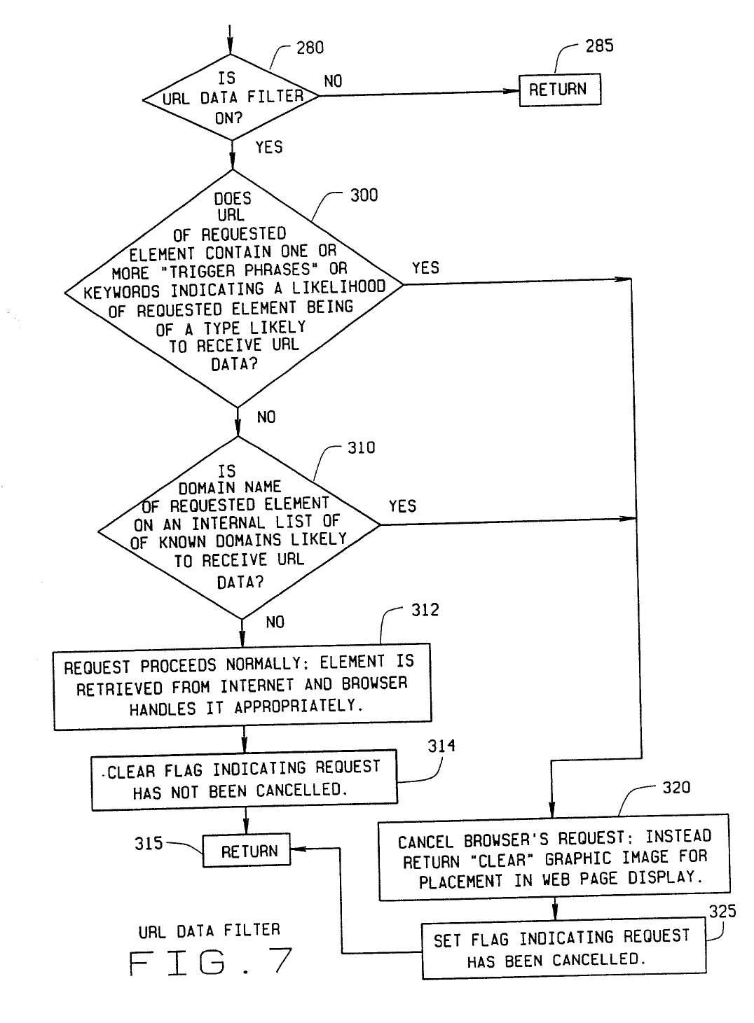

Step 240 then examines the root domain name owning the requested element by transferring execution again, in Step 245, to the Extraction of Name of Root Domain From URL Process in FIG. 4. Once the root domain name is extracted from the non-HTML element, Step 215 of FIG. 4 returns execution to Step 246 of FIG. 5, where the root domain name of the requested element is compared to the root domain name of the Web page itself, saved at Step 170. If these root domain names are the same, execution is transferred to Step 250. If the root domain names are not the same, execution is transferred to Step 247, where execution is transferred to the URL data filter process of FIG. 7.

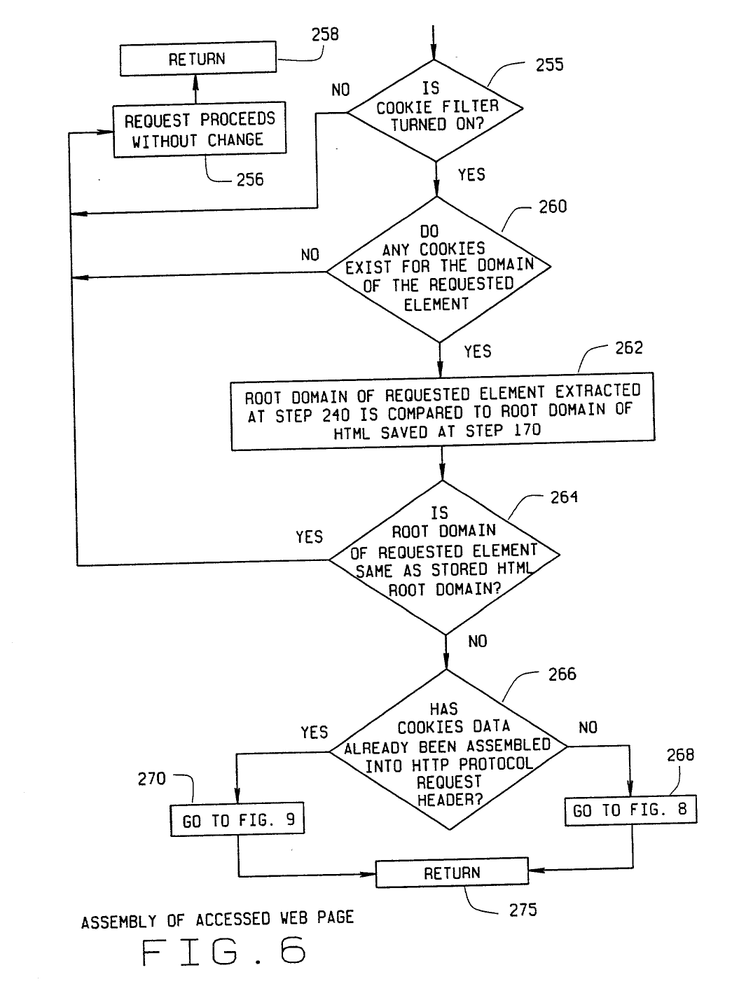

In Step 280 of FIG. 7, a check is made to determine whether the URL data filter has been activated by the user. If not, the process returns in Step 285 to Step 248 where a check is made to see if the flag is set to indicate that the request for the element has been cancelled. If the request has indeed been cancelled, execution is transferred back to Step 220 where the browser assembly of the Web page continues. If the request has not been cancelled, Step 250 transfers execution to Step 255 of FIG. 6, Assembly Of Accessed Web Page Process.

If the test in Step 280 of FIG. 7 indicates the URL data filter is on, Step 300 checks whether the URL of the requested element contains one or more “trigger phrases” or keywords which would indicate a likelihood that the element requested would be of a type to receive the URL data. If it is, Step 320 cancels the browser's request and, rather than displaying the requested element, simply returns a “clear” graphic image for placement in the display of the Web page. Thereafter, Step 325 sets a flag indicating that the request for the element has been cancelled and in Step 315, execution is returned to Step 248 of FIG. 5 where a check is made to determine whether the flag is set indicating the request for the element was cancelled. If the request for the element was cancelled, execution transfers back to Step 220 where the process is repeated until all requested elements have been examined.

If Step 300 of FIG. 7 finds the URL of the requested element contains one or more “trigger phrases” or keywords which would indicate a likelihood that the element requested would be of a type to contain URL data, Step 310 checks to determine whether the domain name of the requested element is on an internal list of domains known to receive URL data. If so, execution is transferred to Step 320 where the requests is cancelled. If not, Step 312 allows the request to proceed normally and the browser retrieves the element. Thereafter, the flag indicating a requests has not been cancelled is cleared in Step 314 and execution is returned in Step 315 to Step 248 of FIG. 5.

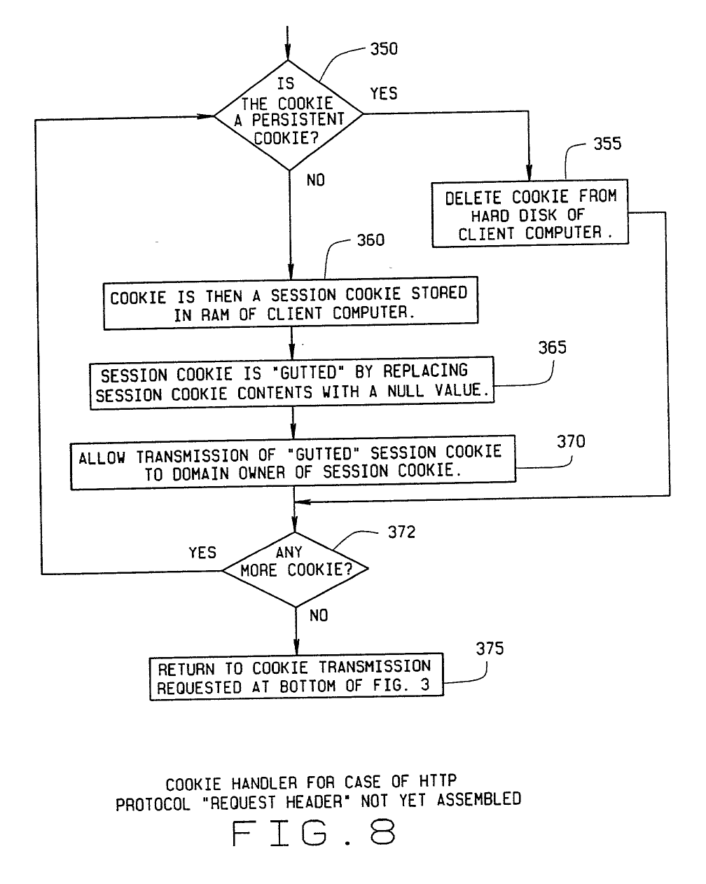

If the flag indicating request has been cancelled is set, execution transfers to Step 225. If the flag has not been set, Step 250 transfers execution to FIG. 6, Step 255 where a test determine if the cookie filter has been activated. If not, Step 256 allows the request for transmission of the cookie to proceed and Step 258 returns execution to Step 250 of FIG. 5 where the assembly of the Web page continues as described above. If Step 255 determines that the cookie filter is activated, Step 260 checks the client computer to determine if any cookies exist for the domain of the requested element. If not, execution is transferred to Steps 256 and 258 for continued assembly of the Web page. If the answer to Step 260 is true, however, in Step 262, the root domain of the requested element which was previously extracted in Step 240 is compared to the root domain stored in Step 170. If the test in Step 264 indicates the root domain of the requested element is the same as the domain stored in Step 170, execution transfers to Steps 256 and 258 and the assembly of the accessed Web page continues and the request for the transmission of the cookie is executed. If the root domain of the requested element is not the same as the domain stored in Step 170, Step 266 checks to determine if the cookie data has already been assembled into the HTTP protocol request header. When the cookie data has not been assembled into the HTTP protocol request header, execution is transferred in Step 268 to FIG. 8, Cookie Handler For Case Of HTTP Protocol “Request Header” Not Yet Assembled Process.

In FIG. 8, Step 350 examines the cookie to determine if the cookie is a persistent cookie, and if so, the cookie is deleted from the hard disk of the client computer in Step 355. When the cookie is not a persistent cookie, then in Step 360, the cookie must be a “session” cookie which is stored in the RAM of the client computer. In Step 365, the session cookie In RAM is gutted by replacing the contents of the session cookie with a null value and in Step 370, the gutted cookie is allowed to be transmitted to the domain owner of the session cookie. Because the session cookie contains a null value, no user data is transmitted from the client computer to the host computer.

Step 372 then tests to determine if there are any more cookies. If more cookies exist, execution is transferred to Step 350 for further handling of the remaining cookies. This process defined in Steps 350 through 372 is repeated until all cookies have been examined and handled. If there are no more cookies, in Step 375 execution is returned to Step 268 where, in Step 275, execution is returned to Step 250 of FIG. 5.

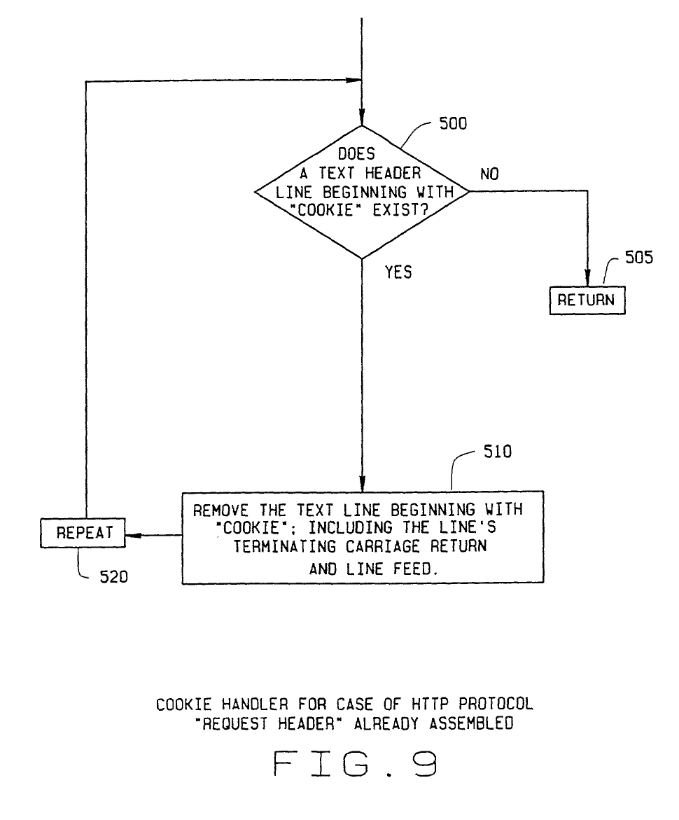

Returning again to Step 266 of FIG. 6, if the cookies data has already been assembled into an HTTP protocol request header, Step 270 transfers execution to Step 500 of FIG. 9, Cookie Handler For Case Of HTTP “Request Header” Already Assembled Process. Step 500 checks to determine whether a text header line beginning with the word “cookie” exists in the HTTP request header. If not, Step 505 returns execution to Step 275 where execution is returned to Step 250 to continue the assembly of the accessed Web page. However, if there is a text header line beginning with the word “cookie”, execution is transferred to Step 510 where the text line beginning with the word “cookie”, including the line's terminating carriage return and line feed are removed. Step 510 then transfers execution back to Step 500 through Step 520 where the process is repeated until there are no text header lines beginning with the word “cookie.” At that time Step 505 returns execution to Step 275 of FIG. 6, and from there to Step 250 of FIG. 5 where the assembly of the accessed page continues.

Once the assembly of the accessed Web page is complete, Step 253 returns the process execution to Step 195 of FIG. 3. There, the final result of the process described in the present invention is the display of the new user accessed Web page on the client computer without the unwanted transmission of any cookie or URL information, directly or indirectly, from the client computer to the host computer. In the event the user requests that another new Internet Web page be accessed, Step 150 repeats the entire process of the invention to again prohibit the unwanted transmission of data.

As various changes could be made in the above constructions without departing from the scope of the invention, it is intended that all matter contained in the above description or shown in the accompanying drawings shall be interpreted as illustrative and not in a limiting sense.

What I claim is:

1. A method for filtering the transmission of data on a computer network comprising the step of preventing a transmission of data from a client computer to a host computer when the host computer is not an owner of a Web page accessed by the client computer.

2. The method of claim 1 further comprising the steps of:
detecting a request for a data transmission from the client computer to the host computer;
determining whether the request for a data transmission is destined for a domain owning the Web page accessed by the client computer; and
preventing the data transmission from the client computer to the host computer when the data transmission is not destined for the domain owning the Web page accessed by the client computer.

3. A method for filtering the transmission of data on a computer network, comprising the steps of:
identifying a domain name owning a Web page accessed by a client computer;
detecting a request for a data transmission from the client computer to a host computer;
identifying a destination domain name of the request for the data transmission from the client computer to the host computer;
determining whether the data transmission from the client computer to the host computer is destined for the domain owning the Web page accessed by the client computer; and
preventing a transmission of the data transmission from the client computer to the host computer when the requested data transmission is not destined for the domain owning the Web page accessed by the client computer.

4. The method of claim 3 wherein identifying the domain name owning the accessed Web page is accomplished by using an Internet Two-Dot Ownership test.

5. The method of claim 4 wherein identifying of the domain name making the request to transmit the cookie from the client computer to the host computer is accomplished by using an Internet Two-Dot Ownership test.

6. The method of claim 5 wherein identifying the domain name owning the accessed Web page includes saving the domain name owning the accessed Web page on a domain list within the client computer.

7. The method of claim 3 wherein detecting the request for a data transmission from the client computer to a host computer is accomplished by examining the components of an HTML element of the accessed Web page.

8. The method of claim 3 wherein the detecting the request for a data transmission from the client computer to the host computer is accomplished by examining the components of a non-HTML element of the accessed Web page.

9. The method of claim 3 wherein preventing the transmission of data from the client computer to the host computer includes processing the transmission request through a cookie filter.

10. The method of claim 9 including allowing a user of the client computer to selectively activate or de-activate the cookie filter.

11. The method of claim 10 including displaying an indicator graphic on a tool bar of an Internet browser program to inform the user of the activation status of the cookie filter.

12. The method of claim 11 wherein the indicator graphic is displayed brightly on the tool bar of the Internet browser program when the cookie filter is activated.

13. The method of claim 11 wherein the indicator graphic is displayed dimly on the tool bar of the Internet browser program when the cookie filter is not activated.

14. The method of claim 9 wherein the cookie filter compares the destination domain name of the destination of the data transmission from the client computer to the domain name owning an accessed Web page accessed by a client computer.

15. The method of claim 14 wherein preventing the transmission of the data transmission from the client computer to the host computer occurs when the destination domain name of the destination of the data transmission from the client computer to the host computer is not the same as the domain name owning the accessed Web page accessed by the client computer.

16. The method of claim 15 wherein preventing the transmission of data from the client computer to the host computer includes deleting an HTTP header request line beginning with the word “cookie.”

17. The method of claim 15 wherein preventing the transmission of data from the client computer to the host computer includes determining whether the cookie is at least one of a session cookie and a persistent cookie.

18. The method of claim 17 wherein the cookie is a session cookie and the transmission of data from the client computer to the host computer includes replacing the contents of the session cookie with a null value.

19. The method of claim 18 wherein preventing the transmission of data from the client computer to the host computer includes allowing the transmission of the session cookie with the null value.

20. The method of claim 17 wherein the cookie is a persistent cookie and preventing the transmission of data from the client computer to the host computer includes deleting the persistent cookie from a hard drive of the client computer.

21. The method of claim 3 wherein preventing the transmission includes processing the transmission request through a MRL data filter.

22. The method of claim 21 includes allowing a user of the client computer to selectively activate or de-activate the URL data filter.

23. The method of claim 22 including displaying an indicator graphic on a tool bar of an Internet browser program to inform the user whether the URL data filter is activated or deactivated.

24. The method of claim 23 wherein the indicator graphic is displayed brightly on the tool bar of the Internet browser program when the URL data filter is activated.

25. The method of claim 23 wherein the indicator graphic is displayed dimly on the tool bar of the Internet browser program when the URL data filter is not activated.

26. The method of claim 21 wherein preventing the transmission of data from the client computer to the host computer occurs if a destination URL contains at least one keyword indicating a likelihood of a requested Web page element being of a type likely to contain URL data.

27. The method of claim 21 wherein preventing the transmission of data from the client computer to the host computer occurs if the destination URL is on an internal list, stored within the client computer, of domains known to receive URL data.

28. The method of claim 3 wherein detecting the request for a transmission of data from the client computer to a host computer includes displaying a cookie counter on a tool bar of an Internet browser program which increments upward one count for each request for transmission of data from the client computer to the host computer.

29. The method of claim 28 including allowing a user of the client computer to reset the cookie counter.

30. A computer apparatus comprising a client computer on a computer network, the client computer having a computer program capable of preventing a transmission of data from the client computer to a host computer when the host computer is not an owner of a Web page being accessed by the client computer.

31. A computer apparatus for providing a user with the ability to prevent an unwanted data transmission from a client computer to a host computer, the computer apparatus comprising:
a client computer linked to a network;
a display monitor linked to the computer;
a non-volatile data storage device; and
a computer program stored on the non-volatile data storage device, the computer program being capable of providing an identification of a domain name owning an accessed Web page accessed by the client computer, detecting a request for a transmission of data from the client computer to a host computer, identifying the domain name making the request for transmission of data from the client computer to the host computer, identifying a destination domain name of the request for the transmission of data from the client computer to the host computer, determining whether the transmission of data from the client computer to the host computer is destined for the domain owning the accessed Web page, and preventing transmission of data from the client computer to the host computer when the requested data transmission is not destined for the domain owning the accessed Web page accessed by the client computer.

32. The computer apparatus of claim 31 wherein detecting a request for a data transmission from the client computer to a host computer is accomplished by examining the components of a non-HTML element of the accessed Web page.

33. The computer apparatus of claim 31 wherein a user of the client computer can selectively activate or de-activate a cookie filter.

34. The computer apparatus of claim 33 further including an indicator graphic which is displayed on a tool bar of an Internet browser program to inform the user of an operational status the cookie filter, the indicator graphic being displayed brightly on the tool bar of the Internet browser program when the cookie filter is activated, the indicator graphic being displayed dimly on the tool bar of the Internet browser program when the cookie filter is not activated.

35. The computer apparatus of claim 31 wherein preventing the transmission of data from the client computer to the host computer includes determining whether the cookie is at least one of a session cookie and a persistent cookie.

36. The computer apparatus of claim 35 wherein the cookie is a session cookie and the transmission of data from the client computer to the host computer includes replacing the contents of the session cookie with a null value.

37. The computer apparatus of claim 36 wherein preventing the transmission of data from the client computer to the host computer includes allowing the transmission of the session cookie with the null value.

38. The computer apparatus of claim 35 wherein the cookie is a persistent cookie and preventing the transmission of data from the client computer to the host computer includes deleting the persistent cookie from a hard drive of the client computer.

39. The computer apparatus of claim 31 wherein preventing the transmission of data from the client computer to the host computer includes processing the transmission request through a URL data filter.

40. The computer apparatus of claim 39 wherein a user of the client computer can selectively activate or de-activate the URL data filter, and further including an indicator graphic which is displayed on a tool bar of an Internet browser program to inform the user whether the URL data filter is activated or de-activated, the indicator graphic being displayed brightly on the tool bar of the Internet browser program when the URL data filter is activated, the indicator graphic being displayed dimly on the tool bar of the Internet browser program when the URL data filter is not activated.

41. The computer apparatus of claim 39 including preventing the transmission of data from the client computer to the host computer if a destination URL contains at least one keyword indicating a likelihood of requested Web page element being of a type likely to contain URL data.

42. The computer apparatus of claim 39 including preventing the transmission of data from the client computer to the host computer if the destination URL is on an internal list, stored within the client computer, of domains known to receive URL data.

43. The computer apparatus of claim 31 wherein detecting a request for a transmission of data from the client computer to the host computer includes displaying a cookie counter on a tool bar of an Internet browser program which increments upward one count for each request for a transmission of data from the client computer to the host computer, the cookie counter being resettable by a user of the client computer.

44. A computer-readable medium having executable instructions for performing functions, the computer-readable medium comprising:
a data storage device; and
a computer program linked with the data storage device, the computer program being capable of providing an identification of a domain name owning an accessed Web page accessed by the client computer, detecting a request for a transmission of data from the client computer to a host computer, identifying the domain name making the request for transmission of data from the client computer to the host computer, identifying a destination domain name of the request for the transmission of data from the client computer to the host computer, determining whether the transmission of the data from the client computer to the host computer is destined for the domain owning the accessed Web page, and preventing transmission of data from the client computer to the host computer when the requested data transmission is not destined for the domain owning the accessed Web page accessed by the client computer.

45. The computer-readable medium of claim 44 wherein detecting a request for a data transmission from the client computer to the host computer is accomplished by examining the components of a non-HTML element of the accessed Web page.

46. The computer-readable medium of claim 45 wherein detecting the request for transmission of data from the client computer to the host computer includes displaying a cookie counter on a tool bar of an Internet browser program, the coolie counter incrementing upward one count for each request to transmit data from the client computer to the host computer, the cookie counter being resettable by a user.

47. The computer-readable medium of claim 44 wherein a user of the client computer can selectively activate or de-activate a cookie filter, and further including an indicator graphic being displayed on a tool bar of an Internet browser program to inform the user whether the cookie filter is activated or de-activated, the indicator graphic being displayed brightly on the tool bar of the Internet browser program when the cookie filter is activated, the indicator graphic being displayed dimly on the tool bar of the Internet browser program when the cookie filter is not activated.

48. The computer-readable medium of claim 44 wherein preventing the transmission of data from the client computer to the host computer includes determining whether a cookie is at least one of a session cookie and a persistent cookie.

49. The computer-readable medium of claim 48 wherein the cookie is a session cookie and the transmission of data from the client computer to the host computer includes replacing the contents of the session cookie with a null value.

50. The computer-readable medium of claim 49 wherein preventing the transmission of data from the client computer to the host computer includes transmission of the session cookie with the null value.

51. The computer-readable medium of claim 48 wherein the cookie is a persistent cookie and preventing the transmission of data from the client computer to the host computer includes deleting the persistent cookie from a hard drive of the client computer.

52. The computer-readable medium of claim 44 wherein preventing the transmission of data from the client computer to the host computer includes processing the request for transmission through a URL data filter.

53. The computer readable medium of claim 52 wherein a user of the client computer can selectively activate or de-activate the URL data filter, and further including an indicator graphic which is displayed on a tool bar of an Internet browser program to inform the user whether the URL data filter is activated or de-activated, the indicator graphic being displayed brightly on the tool bar of the Internet browser program when the URL data filter is activated, the indicator graphic being displayed dimly on the tool bar of the Internet browser program when the URL data filter is not activated.

54. The computer-readable medium of claim 53 including preventing the transmission of data from the client computer to the host computer if a destination URL contains at least one keyword indicating a likelihood of requested Web page element being of a type likely to contain URL data.

55. The computer readable-medium of claim 53 including preventing the transmission of data from the client computer to the host computer if the destination URL is on an internal list of domains known to receive URL data, the internal list being stored within the client computer.

56. A computer apparatus for providing a user with the ability to prevent a transmission of data from a client computer to a host computer, the computer apparatus comprising:
a client computer linked to a network;
means for identifying a domain name owning an accessed Web page accessed by the client computer;
means for detecting a request for a transmission of data from the client computer to a host computer;
means for identifying a domain name making the request to for transmission of data from the client computer to the host computer;
means for identifying a destination domain name of the request for the transmission of data from the client computer to the host computer;
means for determining whether the transmission of data from the client computer to the host computer is destined for the domain name owning the accessed Web page; and
means for preventing the transmission of data from the client computer to the host computer if the transmission of data is not destined for the domain owning the accessed Web page accessed by the client computer.
